(19) United States
(12) Patent Application Publication
(10) Pub. No.: US 2025/0083495 A1
(43) Pub. Date: Mar. 13, 2025

(54) REFRIGERANT SYSTEM, DISTRIBUTION MODULE AND THERMAL MANAGEMENT SYSTEM FOR AN ELECTRIC VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 18/958,567

(22) Filed: Nov. 25, 2024

Related U.S. Application Data
(63) Continuation of application No. PCT/EP2023/057676, filed on Mar. 24, 2023.

(30) Foreign Application Priority Data
May 23, 2022 (DE) 10 2022 112 960.8

(51) Int. Cl. B60H 1/32; B60H 1/00

(52) U.S. Cl. CPC B60H 1/323; B60H 1/00485; B60H 1/3227

(57) ABSTRACT

A refrigerant system for an electric vehicle, comprising a compressor, at least one condenser, at least one expansion device and an evaporator. The aforementioned components interacting in the manner of a heat pump when the refrigerant system is in an operating state. The refrigerant system has a distribution module for fluidically connecting the aforementioned components and for distributing a refrigerant circulating in the refrigerant system. The distribution module comprising a first module part disposed fluidically between a compressor outlet of the compressor and a condenser inlet of the at least one condenser and a second module part disposed fluidically between a condenser outlet of the at least one condenser and a compressor inlet of the compressor. The first module part being substantially thermally insulated from the second module part by at least one insulating part of the distribution module.

This nonprovisional application is a continuation of International Application No. PCT/EP2023/057676, which was filed on Mar. 24, 2023, and which claims priority to German Patent Application No. 10 2022 112 960.8, which was filed in Germany on May 23, 2022, and which are both herein incorporated by reference.

### BACKGROUND OF THE INVENTION

### Field of the Invention

The present invention relates to a refrigerant system, a distribution module for a refrigerant system, and a thermal management system for an electric vehicle.

### Description of the Background Art

Thermal management systems for electric vehicles having a refrigerant system and a coolant system are already known from the prior art in numerous configurations. The known coolant systems for circulating a liquid coolant comprise a multiplicity of components that the coolant can flow through, wherein the components can be connected to one another, at least in a minimum of one subset, in a coolant-conducting manner by means of valves and by means of coolant lines. Similar applies to the known refrigerant systems for circulation of a refrigerant, comprising the following components: a compressor, at least one condenser, at least one expansion device, and an evaporator, wherein the aforementioned components interact in the manner of a heat pump when the refrigerant system is in an operating state. Complex thermal management systems, such as are required with modern electric vehicles, necessitate a very great number of valves and coolant lines as well as valves and refrigerant lines in the prior art, however. Such systems occupy a great deal of installation space and are expensive. Also, the efficiency of these known thermal management systems is in need of improvement.

This is the starting point for the present invention.

### SUMMARY OF THE INVENTION

It is therefore an object of the present invention to improve a refrigerant system, a distribution module, and a thermal management system for an electric vehicle having a coolant system and a refrigerant system.

This object is attained, in an example, by a refrigerant system for an electric vehicle, which is characterized in that the refrigerant system has a distribution module for fluidically connecting the aforementioned components and for distributing a refrigerant circulating in the refrigerant system, wherein the distribution module has a first module part arranged fluidically between a compressor outlet of the compressor and a condenser inlet of the at least one condenser and has a second module part arranged fluidically between a condenser outlet of the at least one condenser and a compressor inlet of the compressor, and wherein the first module part is substantially thermally insulated from the second module part by means of at least one insulating part of the distribution module. Furthermore, this problem is solved by a distribution module and a thermal management system for an electric vehicle.

An important advantage of the invention is, in particular, that a refrigerant system, a distribution module, and a thermal management system for an electric vehicle having a coolant system and a refrigerant system are improved. On account of the invention, functionally complex refrigerant systems and thermal management systems for electric vehicles can be implemented in a manner that is simpler in terms of design and manufacturing. Accordingly, the construction of the refrigerant system according to the invention, and thus of the thermal management system according to the invention, is simplified substantially so that these systems can be manufactured economically and in a space-saving manner. At the same time, the efficiency of such refrigerant systems and thermal management systems is increased by means of the invention. This is because it benefits the respective system efficiency to substantially thermally separate the high-temperature section fluidically upstream of the at least one condenser from the low-temperature section, whereas a thermal connection of the high-temperature section fluidically downstream of the at least one condenser to the low-temperature section fluidically downstream of the evaporator can be advantageous. Accordingly, a multiplicity of operating states, which is to say operating modes of the system, can in principle be realized at the same time as high efficiency of the refrigerant system, and thus of the thermal management system, with a simply constructed system having few components, valves, and refrigerant lines.

In principle, the thermal management system according to the invention for an electric vehicle and the refrigerant system according to the invention for an electric vehicle can each be freely chosen within broad suitable limits in terms of type, mode of operation, material, and dimensioning. In addition, the invention is not restricted to an application with all-electric vehicles. For example, the invention can also be employed advantageously with so-called hybrid vehicles.

The first module part, the at least one insulating part, and the second module part can be connected to produce an assembly forming the distribution module, preferably that this connection is accomplished by means of one of the aforementioned components of the refrigerant system, especially preferably that this component is designed as one of the at least one condensers. By this means, the construction of the refrigerant system according to the invention is simplified considerably in terms of design and manufacturing. This applies especially to the example, and in particular to the example of this improvement, since the aforementioned component, designed for example as one of the condensers, serves at the same time as a connecting element for mechanically connecting the first module part, the at least one insulating part, and the second module part to produce the aforementioned assembly.

The distribution module according to the invention for the refrigerant system according to the invention can likewise be freely chosen within broad suitable limits in terms of type, mode of operation, material, dimensioning, and arrangement.

At least one valve of the distribution module, preferably a valve of the distribution module that can be designed as a single multiway valve, can be arranged in the first module part. In this way, the aforementioned valve, in particular the valve designed as a single multiway valve, is substantially thermally insulated from the second module part.

An internal heat exchanger, also referred to as IHX, can be arranged in the second module part, wherein the internal heat exchanger is designed and arranged in such a manner that a heat exchange between a refrigerant line arranged fluidically upstream of the evaporator and a refrigerant line arranged fluidically downstream of the evaporator is made possible by means of the internal heat exchanger. By this means, an advantageous thermal connection of the high-temperature section to the low-temperature section of the refrigerant system in the second module part is made possible. It is possible, for example, that at least one refrigerant line—designed as a return line—of the low-temperature section downstream of the evaporator is arranged merely in spatial proximity to at least one refrigerant line of the high-temperature section downstream of the at least one condenser for this purpose, so that an advantageous heat transfer between these two sections of the refrigerant system according to the invention can be produced in a manner that is very simple in terms of design and manufacturing.

At least one of the at least one expansion devices, for example, an expansion device that can be designed as an expansion valve, can be arranged in the second module part. In this way, the degree of concentration of components of the refrigerant system according to the invention is further increased in the distribution module according to the invention. In this context, an arrangement of all expansion devices in the second module part would be especially advantageous.

The at least one insulating part of the distribution module according to the invention can be freely chosen within broad suitable limits in terms of type, mode of operation, material, dimensioning, and arrangement. An advantageous improvement of the distribution module according to the invention provides that at least one of the at least one insulating parts has an opening for through-passage of a refrigerant line of the distribution module, preferably that this refrigerant line can be fluidically connected to the multiway valve, especially preferably that this refrigerant line is fluidically connected to a refrigerant line of the distribution module that is fluidically connected to the compressor inlet of the compressor. By this means, a necessary fluidic connection of the distribution module according to the invention through the thermal insulation is made possible, despite substantial thermal insulation of the first module part from the second module part. The example and, in particular, the example of this improvement specify especially advantageous fluidic connections between the first module part on the one side of the insulating part and the second module part on the other side of the insulating part. This opening in the thermal insulation can be thermally sealed, with the exception of the aforementioned fluidic connection, using means and measures suitable for the application in question. The person skilled in the art is familiar with means and measures suitable for this purpose in accordance with the requirements of the individual case.

As already explained above, the thermal management system according to the invention can be freely chosen within broad suitable limits.

One of the at least one condensers can be designed as a liquid-cooled condenser, wherein this condenser can be fluidically connected to the coolant system. A demand-based heat transfer connection between the coolant system on the one side and the refrigerant system on the other side can consequently be produced by means of the condenser. For example, the condenser can be arranged in a coolant-conducting manner in a drive train sub-circuit of the coolant system. The condenser, a component that is present in a conventional refrigerant system for an electric vehicle, can thus be used both for operation of the refrigerant system and for heat transfer between the coolant system on the one side and the refrigerant system on the other side.

The distribution module can be fluidically connected to a chiller of the thermal management system, wherein the chiller makes possible a heat exchange between the refrigerant system on the one side and the coolant system on the other side. A demand-based heat transfer connection between the coolant system on the one side and the refrigerant system on the other side can consequently be produced by means of the chiller. Accordingly, advantages arise here that are comparable to those of the aforementioned improvement of the thermal management system according to the invention. Firstly, combining the two said improvements of the thermal management system according to the invention additionally yields the possibility of exchanging even more energy between the coolant system and the refrigerant system. Secondly, the flexibility of the thermal management system according to the invention is further increased thereby.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the refrigerant system according to the invention with a distribution module according to the invention in a schematic diagram of the process,

FIG. 2 shows the distribution module of the example from FIG. 1 in a disassembled state,

FIG. 3 shows the distribution module of the example from FIG. 1 in an intermediate state, and

FIG. 4 shows the distribution module of the example from FIG. 1 in an assembled state.

### DETAILED DESCRIPTION

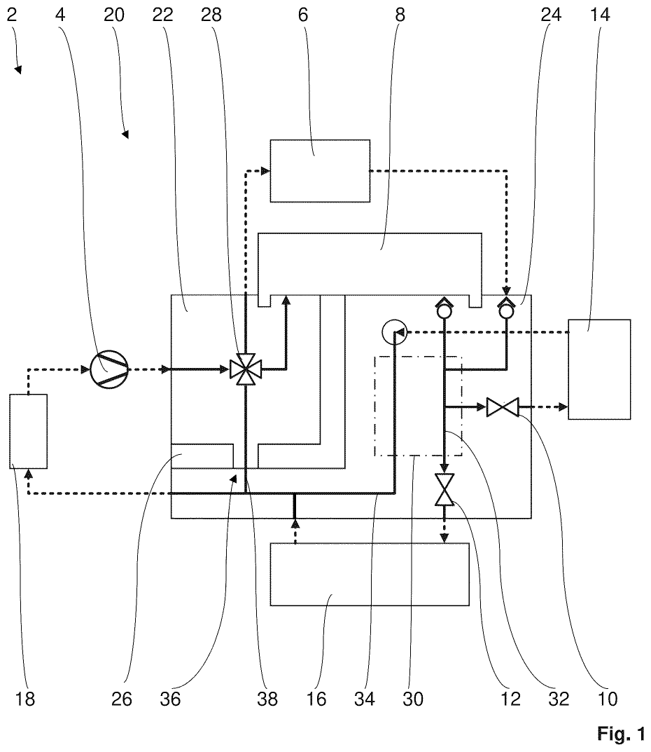

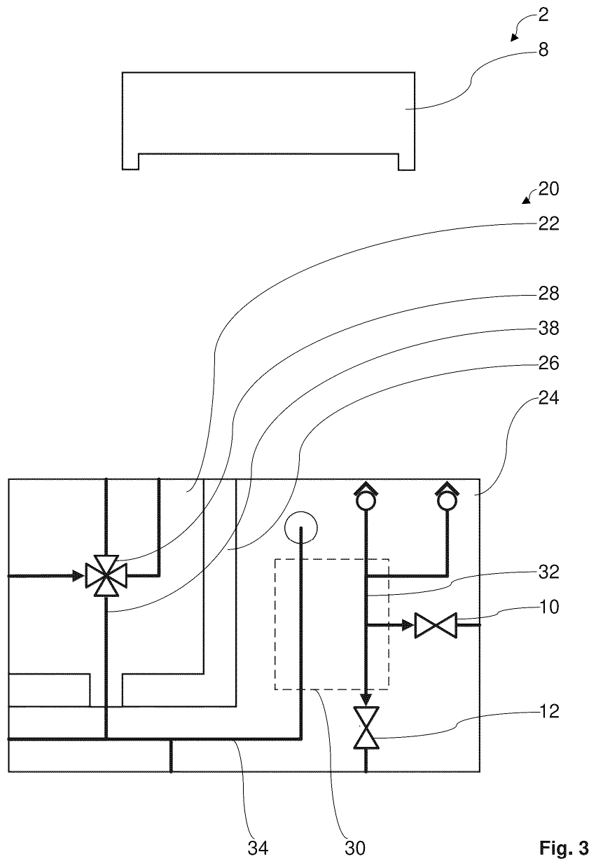

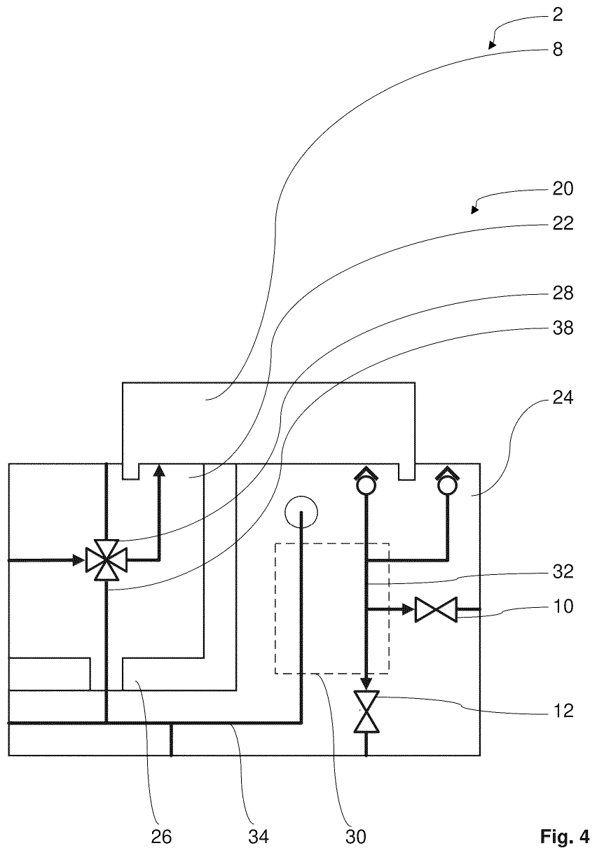

Shown strictly by way of example in FIGS. 1 to 4 is an example of the refrigerant system according to the invention of a thermal management system according to the invention.

The thermal management system is designed as a thermal management system for an all-electric vehicle and comprises a coolant system on the one hand and a refrigerant system 2 on the other hand. The coolant system for circulating a liquid coolant here comprises a multiplicity of components that the coolant can flow through, wherein the components can be connected to one another, at least in a minimum of one subset, in a coolant-conducting manner by means of at least one valve, for example a multiway valve, and by means of coolant lines.

The refrigerant system 2 is designed for air-conditioning a passenger compartment of the electric vehicle and for temperature control of a coolant flowing in the coolant system. The refrigerant system 2 is depicted in FIG. 1, wherein the refrigerant system 2 comprises the following components: a compressor 4, a first condenser 6 and a second condenser 8, a first expansion device 10 and a second expansion device 12, as well as an evaporator 14, wherein the aforementioned components interact in the manner of a heat pump when the refrigerant system 2 is in an operating state. The second condenser 8 is designed here as a liquid-cooled condenser, wherein this condenser 8 can be fluidically connected to the coolant system in a manner that is known per se to the person skilled in the art. The second condenser 8 can therefore be connected indirectly to an open environment in a heat-transmitting manner by means of the liquid coolant. The first condenser 6 and the evaporator 14 are designed here as a so-called interior condenser and as a so-called interior evaporator, and consequently each exchange heat directly with the passenger compartment. The evaporator 14 and the first condenser 6 permit both direct cooling and heating of the interior of the electric vehicle, namely of the passenger compartment. The heat pump, which is to say the refrigerant system 2, makes possible heating functions with a COP >>1. For a specific heat output, only a fraction of this heat output must therefore be provided as electric power.

The refrigerant system 2 in the examples furthermore comprises a chiller 16 and a accumulator 18. The chiller 16 likewise makes possible a heat exchange between the refrigerant system 2 on the one side and the coolant system on the other side. For this purpose, the chiller 16, analogously to the second condenser 8, can be fluidically connected to the coolant system in a manner known per se to the person skilled in the art. The accumulator 18 serves here as a reservoir for the refrigerant of the refrigerant system 2. Other examples of reservoirs for the refrigerant are also possible.

According to the invention, the refrigerant system 2 has a distribution module 20 for fluidically connecting the aforementioned components and for distributing a refrigerant circulating in the refrigerant system 2, wherein the distribution module 20 has a first module part 22 arranged fluidically between a compressor outlet of the compressor 4 and a condenser inlet of the respective condenser 6, 8 and has a second module part 24 arranged fluidically between a condenser outlet of the respective condenser 6, 8 and a compressor inlet of the compressor 4, and wherein the first module part 22 is substantially thermally insulated from the second module part 24 by means of an insulating part 26 of the distribution module 20. The refrigerant is not shown in FIGS. 1 to 4.

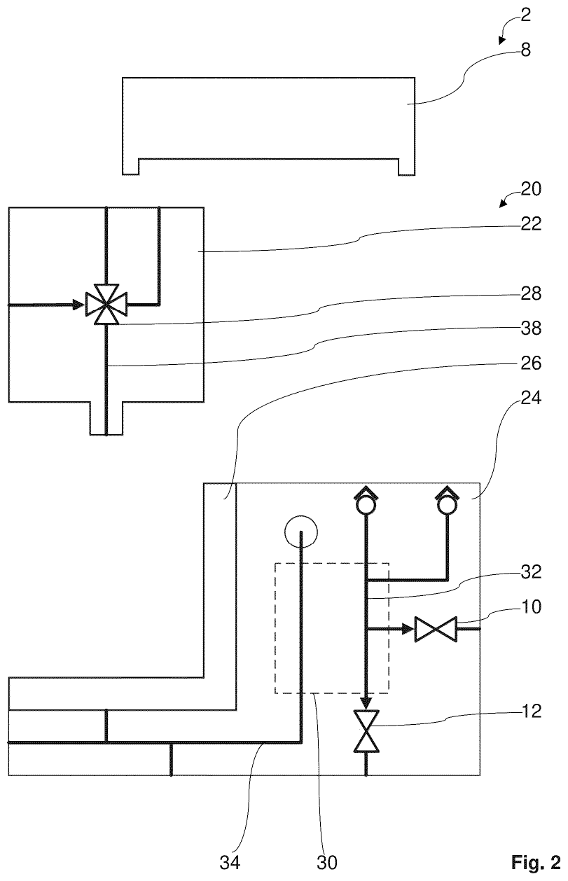

In the present example, the first module part 22, the insulating part 26, and the second module part 24 can be connected to produce an assembly forming the distribution module 20, wherein this connection is accomplished by means of one of the aforementioned components of the refrigerant system 2, namely the second condenser 8. In this regard, see FIGS. 2 to 4 in combination.

A valve 28 of the distribution module 20 designed as a multiway valve is arranged in the first module part 22. Furthermore, an internal heat exchanger 30 is arranged in the second module part 24, wherein the internal heat exchanger 30 is designed and arranged in such a manner that a heat exchange between a refrigerant line 32 arranged fluidically upstream of the evaporator 14 and a refrigerant line 34 arranged fluidically downstream of the evaporator 14 is made possible by means of the internal heat exchanger 30. In addition, the first expansion device 10 designed as a first expansion valve and the second expansion device 12 designed as a second expansion valve are each arranged in the second module part 24.

In the present example, the insulating part 26 has an opening 36 for through-passage of a refrigerant line 38 of the distribution module 20, wherein this refrigerant line 38 can be fluidically connected to the multiway valve 28 and that this refrigerant line 38 is fluidically connected to the refrigerant line 34 of the distribution module 20 that is fluidically connected to the accumulator 18, and thus indirectly to the compressor inlet of the compressor 4.

The mode of operation of the thermal management system according to the invention with the refrigerant system according to the invention and the distribution module according to the invention in accordance with the example is explained in detail below on the basis of FIGS. 1 to 4.

Assembling the refrigerant system 2 with the distribution module 20 in accordance with the example is simplified considerably in comparison with the prior art. The first module part 22, the insulating part 26, and the second module part 24 of the distribution module 20 are connected to one another and held in contact by the second condenser 8 here. In this regard, see FIGS. 2 to 4 in combination. The insulating part 26 can, for example, be preassembled either on the first module part 22 or on the second module part 24, in order to thus further simplify manufacture. After that, the first module part 22 and the second module part 24 are assembled and connected by means of the second condenser 8 to form the distribution module 20 designed as a single assembly. In this process, the aforementioned connection of the second condenser 8 with the first module part 22 and with the second module part 24 creates the necessary contact pressure, for example by screw connections or the like, so that sealing points at interfaces between the first module part 22, the second module part 24, and the insulating part 26 are sealed effectively. By this means, the insulating part 26 is fixed in place between the first module part 22 and the second module part 24 so that it is possible to dispense with direct connection points between the insulating part 26 on the one hand and the first module part 22 and the second module part 24 on the other hand, namely connection points that connect the high-temperature section of the first module part 22 and the low-temperature section of the second module part 24. Consequently, an unwanted heat transfer between the first module part 22 and the second module part 24 is further reduced.

The components of the coolant system can represent heat sources or heat sinks, depending on the operating state of the thermal management system with the refrigerant system 2 and taking into account the driving situation and the ambient temperature.

In principle, the refrigerant system 2 has the aforementioned high-pressure section/high-temperature section (HT section for short) as well as the aforementioned low-pressure section/low-temperature section (LT section for short). In this context, the HT section comprises the section between the compressor outlet of the compressor 4 and the multiway valve 28, thereafter either to the first condenser 6 and/or to the second condenser 8 and then to the expansion valves 10 and 12. The LT section begins after the expansion valves 10, 12 and comprises the section from the expansion valves 10, 12 to the chiller 16 and to the evaporator 14, thereafter to the accumulator 18 and finally to the compressor inlet of the compressor 4. With regard to system efficiency, it is advantageous to thermally separate the HT section upstream of the condensers 6, 8 from the LT section downstream of the condensers 6, 8, whereas a thermal connection of the HT section downstream of the condensers 6, 8 and of the LT section downstream of the evaporator 14 can be advantageous for system efficiency.

By means of the distribution module 20, the components of the refrigerant system 2 are at least partially integrated into a single module. Furthermore, an advantageous thermal separation/connection of the HT and LT sections, as explained above, is made possible by means of the distribution module 20. In FIG. 1, external refrigerant lines, which is to say refrigerant lines on the other side of the distribution module 20, are represented by dashed lines and refrigerant lines in the distribution module 20 by solid lines. The first module part 22 comprises the HT section upstream of the condensers 6, 8, which contains the fluidic connections from the compressor 4 to the multiway valve 28 and to the condensers 6, 8. The second module part 24 comprises the HT section downstream of the condensers 6, 8 as well as the LT section. In this context, the return line of the LT section downstream of the evaporator 14, namely the refrigerant line 34, is arranged in spatial proximity to the refrigerant line 32 of the HT section downstream of the condensers 6, 8 in such a manner that an advantageous heat transfer between these two sections can be produced in the internal heat exchanger 30 thus formed. The internal heat exchanger 30 realized solely in the aforementioned manner is identified in FIGS. 1 to 4 by a dot-and-dash line. Of course, other examples of the internal heat exchanger, if present, are also possible.

The efficiency of the overall system, which is to say of the thermal management system with the coolant system and the refrigerant system 2, can be improved by a demand-oriented connection or separation of the individual components of the refrigerant system. This takes place according to the invention with a simultaneous high efficiency of the overall system. The coolant system on the one side and the refrigerant system 2 on the other side can be connected in a heat-transmitting manner by means of the second condenser 8 and the chiller 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A refrigerant system for an electric vehicle, the system comprising:
a compressor;
at least one condenser;
at least one expansion device;
an evaporator, the compressor, the at least one condenser, the at least one expansion device, and the evaporator interact in the manner of a heat pump when the refrigerant system is in an operating state;
a distribution module to fluidically connect the compressor, the at least one condenser, the at least one expansion device, and the evaporator and to distribute a refrigerant circulating in the refrigerant system,
wherein the distribution module has a first module part arranged fluidically between a compressor outlet of the compressor and a condenser inlet of the at least one condenser and has a second module part arranged fluidically between a condenser outlet of the at least one condenser and a compressor inlet of the compressor, and
wherein the first module part is substantially thermally insulated from the second module part via at least one insulating part of the distribution module.

2. The refrigerant system according to claim 1, wherein the first module part, the at least one insulating part, and the second module part are connected to produce an assembly forming the distribution module, wherein this connection is accomplished by one of the compressor, the at least one condenser, the at least one expansion device, or the evaporator of the refrigerant system or wherein this component is designed as one of the at least one condensers.

3. A distribution module for a refrigerant system according to claim 1, wherein the first module part, the at least one insulating part, and the second module part are designed such that the first module part, the at least one insulating part, and the second module part are connected to one another to produce an assembly forming the distribution module.

4. The distribution module according to claim 3, wherein at least one valve of the distribution module or a valve of the distribution module designed as a single multiway valve, is arranged in the first module part.

5. The distribution module according to claim 3, wherein an internal heat exchanger is arranged in the second module part, wherein the internal heat exchanger is designed and arranged such that a heat exchange between a refrigerant line arranged fluidically upstream of the evaporator and a refrigerant line arranged fluidically downstream of the evaporator is made possible by the internal heat exchanger.

6. The distribution module according to claim 3, wherein at least one of the at least one expansion devices, or an expansion device designed as an expansion valve, is arranged in the second module part.

7. The distribution module according to claim 3, wherein at least one of the at least one insulating parts has an opening for through-passage of a refrigerant line of the distribution module, or wherein the refrigerant line is fluidically connected to the multiway valve, or wherein the refrigerant line is fluidically connected to a refrigerant line of the distribution module that is fluidically connected to the compressor inlet of the compressor.

8. A thermal management system for an electric vehicle, comprising:
a refrigerant system for circulation of a refrigerant; and
a coolant system for circulation of a liquid coolant that is connectable in a heat-transmitting manner to the refrigerant system according to claim 1.

9. The thermal management system according to claim 8, wherein one of the at least one condensers is a liquid-cooled condenser and is fluidically connected to the coolant system.

10. The thermal management system according to claim 8, wherein the distribution module is fluidically connected to a chiller of the thermal management system, and wherein the chiller makes possible a heat exchange between the refrigerant system and the coolant system.
